(19) United States
(12) Patent Application Publication
(10) Pub. No.: US 2007/0258139 A1
(43) Pub. Date: Nov. 8, 2007

(54) IMAGE DISPLAY APPARATUS

(75) Inventors: Chao-Hsu Tsai, Hsinchu City (TW); Kuen Lee, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/554,598

(22) Filed: Oct. 31, 2006

(30) Foreign Application Priority Data
May 4, 2006 (TW) 95115850

(51) Int. Cl. G02B 27/22

(52) U.S. Cl. 359/462; 359/464

(57) ABSTRACT

An image display apparatus can display a stereo image, including an image display panel. An image sequence is alternatively displayed in at least two parallax images for forming a stereo image. A tracking-slit panel is at one side of the image display panel with several parallel slit regions extending vertically. A lenticular plate is disposed between the image display panel and the tracking-slit panel. The lenticular plate has several parallel lenticular bars. One lenticular bar corresponds to a slit group, having a fixed number of slit regions. A detection control unit determines which viewing position to display the stereo image and controls each slit region of the tracking-slit panel. According to the viewing position, the slit region of each slit group is at least divided into a first set and a second set, respectively corresponding to the two parallax images, alternatively turning slit regions on/off.

### CROSS-REFERENCE TO RELATED APPLICATION

This application claims the priority benefit of Taiwan application serial no. 95115850, filed May 4, 2006. All disclosure of the Taiwan application is incorporated herein by reference.

### BACKGROUND OF THE INVENTION

1. Field of Invention

The present invention relates to technology of autostereoscopic image display. More particularly, the present invention relates to an image display apparatus capable of displaying a stereo image with automatic tracking to the viewer.

2. Description of Related Art

Image is an efficient manner to transmit information. The image can be printed on a paper. In addition, as the development of scientific technology, a large amount of images are displayed on a display apparatus in digital manner. Since the screen of the display apparatus is a flat panel structure, composed of pixel array, it usually has no stereo effect in displaying image.

However, according to the vision properties of human eye, when the left eye and the right eye are respectively viewing two images having the same image content but with vision disparity, a stereo image can be formed. In the earlier technology for displaying stereo image, a polarization effect is used, in which the two images are output and the viewer separately views the two images by a polarized eyeglasses, so as to form the stereo effect. This kind of stereo displaying manner is inconvenient in use. Therefore, the technology of autostereoscopic display is under active development.

The 3D display apparatus would be the essential trend in development for the next generation of display apparatus and has been commonly realized by the industry. However, the 3D display technology is still not popular and encounters some barriers. Although it has the issue of the human factor and in-short content, the main barrier is still coming from the limitation of the display technology itself.

One of the main bottlenecks for the technology of autostereoscopic display is that both the display resolution and the freedom of the viewing position cannot be improved at the same time. Most of the technologies take the way that the pixels of the display apparatus are divided into several groups, directing to different directions, so that the viewer can view different images from different directions. If the number of the divided groups is larger, the viewer can be freer in move while the 3D vision can still remain. However, the image resolution becomes worse.

### SUMMARY OF THE INVENTION

The invention provides an image display apparatus for displaying a stereo image, having function of automatic tracking of the viewers. As a result, the image resolution is not decreased and the viewers' head a higher degree of freedom of motion can still be allowed.

The invention provides an image display apparatus, for allowing several viewers to simultaneously view the stereo image.

The invention provides an image display apparatus, in which the view zone can be smoothly changed, so as to reduce the error or the serious phenomenon of ghost-image due to the movement of the viewer. In addition, the position of the viewer can be easily tracked.

The invention provides an image display apparatus, having more compact assembly for reducing the volume.

The invention provides an image display apparatus, capable of displaying the stereo image or the two-dimensional image under switching. The image display apparatus includes image display panel, with respect to an image, at least two parallax images are alternatively displayed under an operation frequency. The two parallax images are the left-eye and right-eye parts of a stereo image. The operation frequency is at least two times of a visual frequency. A first side of the image display panel can be viewed with the stereo image. A tracking-slit panel is disposed at a second side of the image display panel. The tracking-slit panel has several slit regions arranging in parallel and extending along a pixel column direction of the image display panel. A lenticular plate is disposed between the image display panel and the tracking-slit panel. The lenticular plate has several parallel lenticular bars, in which every fixed number of the slit regions of the tracking-slit panel is set as a slit group, corresponding to one of the lenticular bars. A detection and control unit determines which viewing position to throw the stereo image to and controls each of the slit regions of the tracking-slit panel. According to the viewing position, the slit regions of each slit group is at least divided into a first set and a second set, respectively corresponding to the two parallax images and alternatively turning slit regions on/off. After the light (from the backlight module) passing through the slit regions, the lenticular plate and the image display panel, the image is formed and reaches to the viewing position.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view, schematically illustrating an autostereoscopic image display apparatus, according to a preferred embodiment of the invention with spatial light modulator as the tracking-slits and backlight module as the light source.

FIG. 2 is a drawing, schematically illustrating a control mechanism of the tracking-slit panel, according to a preferred embodiment of the invention.

FIG. 3 is a drawing, schematically illustrating an operation mechanism for multiple viewers, according to a preferred embodiment of the invention.

FIG. 4 is a drawing, schematically illustrating another operation mechanism with multiple slits to form a view zone, according to a preferred embodiment of the invention.

FIG. 5 is a drawing, schematically illustrating the structure of the tracking-slit panel.

FIG. 6 is a drawing, schematically illustrating another operation mechanism, according to a preferred embodiment of the invention with four view zones.

FIG. 7 a top view, schematically illustrating another structure of an autostereoscopic image display apparatus, according to a preferred embodiment of the invention with active light emitting device as the tracking-slits.

### DESCRIPTION OF THE PREFERRED EMBODIMENTS

The invention proposes to use the viewer tracking technology, so that the left-eye and right-eye images needed by the two eyes of the viewer are respectively projected to the positions of the left eye and the right eye. When the head of the viewer is moving, the projection positions will accordingly move, so that it allows the head of the viewer to be freely moving while the image resolution remains high. The invention uses the fast-display apparatus with the implementation of tracking-slit and lenticular plate, so as to at least achieve the capability of the autostereoscopic display with full resolution. Several embodiments are provided for descriptions but not for limiting the invention.

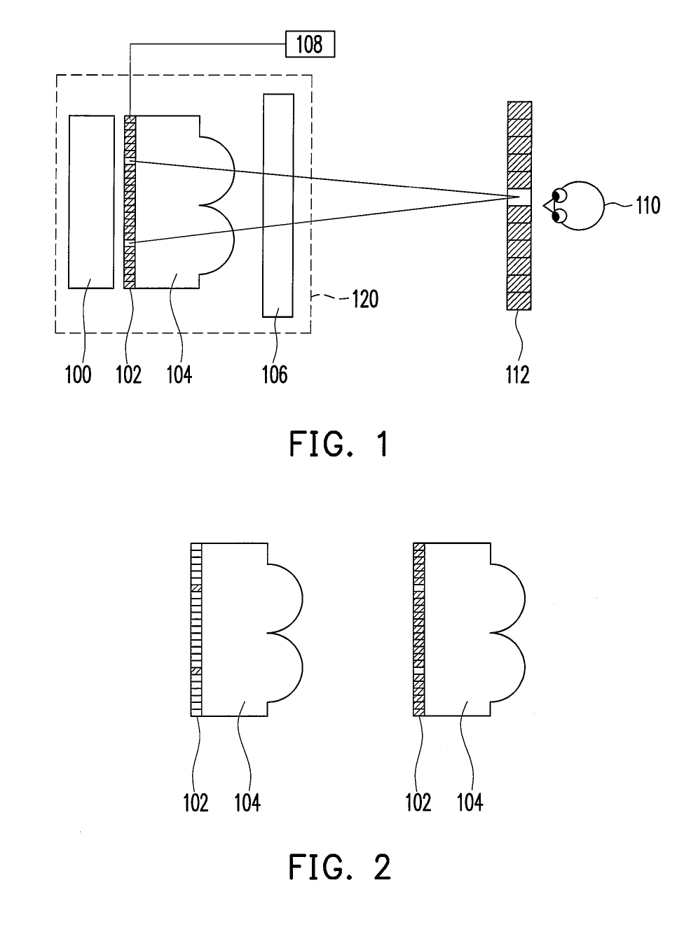

FIG. 1 is a top view, schematically illustrating an autostereoscopic image display apparatus, according to a preferred embodiment of the invention. The display apparatus 120 of the invention is taking the liquid crystal display (LCD) technology as the example for describing the manner of displaying image. Basically, the apparatus includes a backlight module 100, a tracking-slit panel 102, a lenticular plate 104, an image display panel 106, and a detection and control unit 108. The viewer 110 can view the image of the image display panel 106 by both eyes at a viewing position. A nonphysical parallax space 112 is created at the position of the viewer 110.

The invention arranges a to-be-displayed stereo image to have at least two parallax images of different view angle. For a rather simpler way, the displayed image can be divided into two parallax images, for example, respectively corresponding to the left-eye view zone and the right-eye view zone. As a result, the left-eye image can enter the left eye of the viewer 110 and the right-eye image can enter the right eye of the viewer 110. In this manner, the viewer 110 can automatically see the stereo image. The two parallax images are alternatively generated by the image display panel 106 under a time sequence. In considering the visual effect, the operation frequency of the image display panel 106 preferably is at least twice of the visual frequency. Usually, the visual frequency is at the range of 50 Hz-60 Hz. Taking 60 Hz as the example, then the operation frequency of the image display panel 106 is 120 Hz or higher. Thus, after the combination of the left-eye image and the right-eye image, it still satisfies the visual frequency of 60 Hz without influencing the visual effect. Further in the embodiment, since the image display panel 106 is based on the LCD technology to display the image, the backlight module is used to provide the needed light source. However, if there is other light source for replacement of the tracking-slit panel, then the backlight module 100 may not be necessary. For example, if the tracking-slit panel 102 is composed from the light emitting device with capability to actively emit light, the backlight module 100 is not necessary.

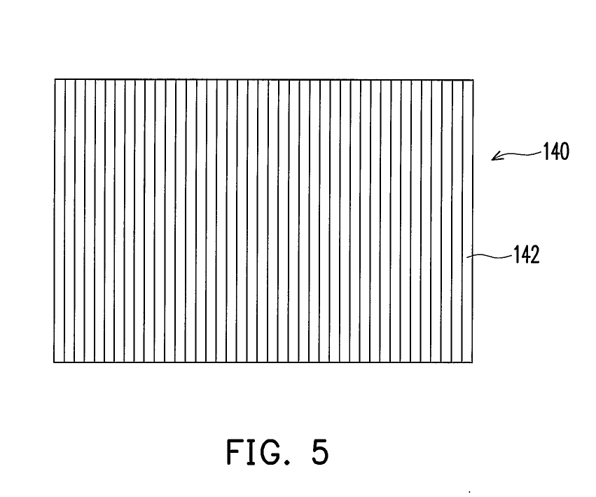

In order to let the left-eye image and the right-eye image from the image display panel 106 be respectively projected to left eye and right eye of the viewer 110, it can be achieved in the invention by using the tracking-slit panel 102, the lenticular plate 104 and the detection and control unit 108 in operation together. The tracking-slit panel 102 is disposed at one side of the image display panel 106, that is, at the location between the backlight module 100 and the image display panel 106. The tracking-slit panel 102 has multiple slit regions arranged in parallel, to be described in FIG. 5 later. The longitudinal direction of the slit regions is extending along a pixel column direction of the image display panel. In other words, it is the direction perpendicular to a horizontal direction formed by the both eyes. Each of the slit regions can be controlled by the detection and control unit 108 to be at on state or offstate. Here, the on state or off state indicates whether or not the light from the backlight module 100 can pass. If the tracking-slit panel 102 is designed with actively emitting light, then the on state or off state indicates whether or not the slit region is emitting light. The produced effect and mechanism of the tracking-slit region 102 will be described later.

In continuing, the lenticular plate 104 is disposed between the tracking-slit panel 102 and the image display panel 106. The lenticular plate 104 is also composed of several lenticular bars arranged in parallel. FIG. 1 just shows the two lenticular bars, as the example for descriptions. The extending direction of the lenticular bar is the same as that of slit regions of the tracking-slit panel 102. In addition, each lenticular bar is corresponding to a fixed number of slit regions. For easy descriptions, the fixed number of slit regions is also called a slit group, which is disposed with respect to one lenticular bar. For example, the actual number can be 100 lenticular bars on the lenticular plate 104. Further for example, if one slit group has 20 slit regions, then the total number of the slit regions on the tracking-slit panel is 2000. The number of the slit regions in the slit group is in relation with the moving freedom of the viewer 110, that is, it for example allows the viewer 110 to have 20 steps of the viewing angles in shifting. Further, each slit region of the tracking-slit panel 102 is, for example, a spatial light modulator (SLM) for controlling whether or not the light can pass. However, the SLM is just an example. Other device or structure with similar function to control whether or not the light can pass cal also be used to form the tracking-slit panel 102.

The lenticular bar of the lenticular plate 104 can project the light from the tracking-slit panel onto the image display panel 106, so that the parallax images of the image display panel 106 can be seen by the respective eye of the viewer 110. Due to the effect of persistence of vision, although the left-eye image and the right-eye image are sequentially entering the left eye and the right eye, a stereo image can be produced after the overlapping.

The parallax space 112 in front of the display apparatus 120 can be expected. As shown in FIG. 1, in the tracking-slit panel 102, the white slit region represents an on state, and the passing light can enter a position of the parallax space 112, such as the right-eye position, via each lenticular bar of the lenticular plate 104. The image display panel 106 can simultaneously display the image belonging to the right-eye view zone. Next, in the tracking-slit panel 102, the slit regions previously at on state are changed to the off state while the slit regions previously at off state are changed to the on state. Then, the passing light through the slit regions with on state can enter the other part of the parallax space 112 which was previously dark at the earlier moment, such as the position other than the right-eye position, via each lenticular bar of the lenticular plate 104. The left eye of the viewer can receive this passing light at this moment. The image display panel 106 can simultaneously display the image belonging to the left-eye view zone.

The detection and control unit 108 can detect whether or not a viewer 110 enters a viewing region, so as to determine whether or not the stereo image is to be displayed at the viewing position and where is the viewing position. In addition, the detection and control unit 108 also controls each slit region of the tracking-slit panel 102. According to the viewing position, the slit regions of each slit group are at least divided into a first set and a second set, respectively corresponding to two parallax images of both eyes, in alternatively turning the lit regions on and off.

For an easier situation with respect to the embodiment having only one viewer 110, the slit regions of the slit set can be divided into two sets. FIG. 2 is a drawing, schematically illustrating a control mechanism of the tracking-slit panel 102, according to a preferred embodiment of the invention. In FIG. 1 and FIG. 2, for example, the right-eye image is provided by the light source from one slit region in the slit group. The other portion of the slit regions for another eye, such as the left eye, can be treated as another for control. In left drawing of FIG. 2, for example, is the light source for the left eye, while the right drawing is the light source for the right eye. In the light source of left eye, although most of the slit regions are turned on, the slit regions capable of entering the left eye are dominated by the slit region adjacent to the right-eye view zone. The light from the other slit regions are basically not enter the left eye. However, this kind of arrangement is in easy control. It is also possible to arrange each of the left-eye image and the right-eye image to have just one slit region for producing the light. However, the control is relatively complicate. The invention is not limited to any specific manner. In other words, according to the practical design, the slit regions of the slit group can be divided into at least two sets for control.

After the detection control unit 108 has detected the viewing position of the viewer 110, according to the setting for the left eye and the right eye, the slit region are divided into corresponding two sets, which are alternatively turned on or off under a time sequence. For the practical designs for the detection and control unit 108 and the tracking-slit panel, the one with ordinary skill can design them following the described mechanism.

In addition, if the viewer 110 is at the far position not within the region for stereo image, or the viewer 110 is within the region for stereo image but just wants to view the planar image (2D image), then the display apparatus 120 can be switched to display the planar image. For example, one of the left-eye image and the right-eye image can serve as a planar image. In this situation, all of the slit regions of the tracking-slit panel 120 are together turned on. For example, when the image display panel 106 is displaying the left-eye image, all of the slit regions of the tracking-slit panel 102 are together turned on, so that the left-eye image is the planar image. Further, vice versa, the right-eye image can be used.

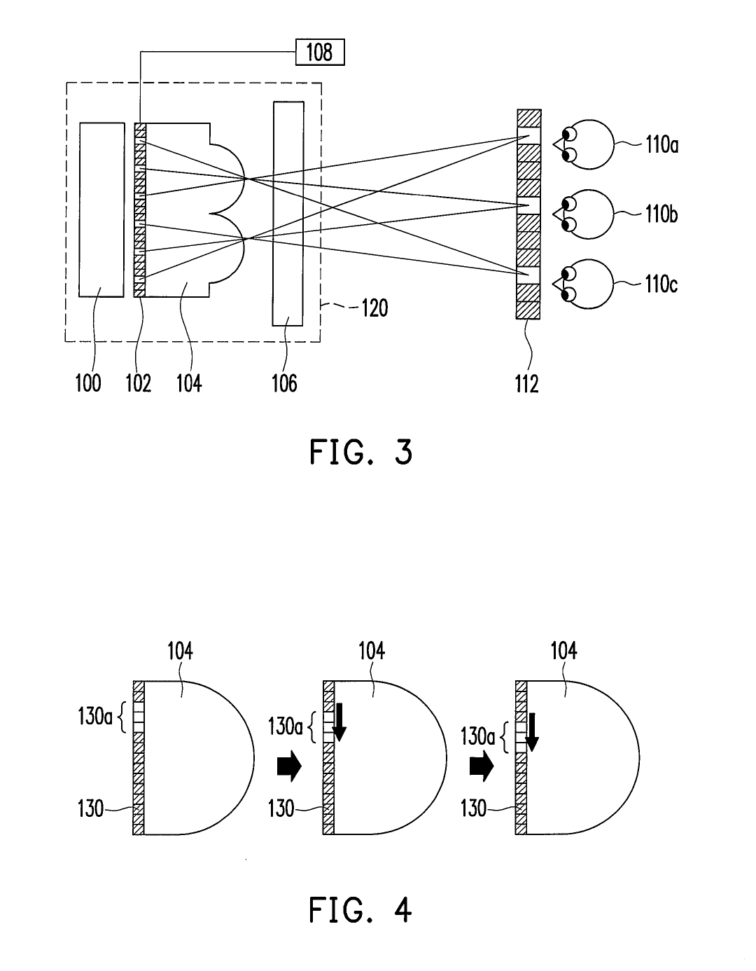

According to the basic structure in FIG. 1, some other displaying function can be added. FIG. 3 is a drawing, schematically illustrating an operation mechanism for multiple viewers, according to a preferred embodiment of the invention. In FIG. 3, when the display apparatus, has multiple viewers 110a, 110b, 110c to simultaneously view the stereo image, each viewer can tracked by the detection and control unit 108 with similar control mechanism to control the tracking-slit panel 102. At this moment, taking three viewers 110a, 110b, 110c as the example, the slit regions of the slit group with respect to one lenticular bar has three slit regions corresponding to the right eyes of the three viewers 110a, 110b, 110c, being turned on at the same time. The other slit regions are belonging to the left-eye view zone. Therefore, the display apparatus 120 of the invention is suitable for multiple persons to view the stereo image.

In addition, if the viewer 110 is moving, the detection and control unit 108 can detect the viewing position of the viewer 110 all the time, and determines the slit regions belonging to the right-eye view zone. FIG. 4 is a drawing, schematically illustrating another operation mechanism, according to a preferred embodiment of the invention. In FIG. 4, for a slit group 130 with respect to a lenticular bar 104, for example, at least one slit region 130a is corresponding to a position of one of both eyes of the viewer, such as the right eye. When the viewer is moving to one direction, as shown by the arrow, the slit region 130a is moving in accordance with movement of the viewer. Preferably, one slit region is shifted for one step of movement. As a result, the display apparatus 120 can change based on tracking the position of the viewer, so as to achieve the effect of tracking and displaying.

Further, since the viewer would move, if the slit region 130a is single, then the tracking quality may be relatively poor. In order to increase the tracking quality, for example, the light source for the right-eye view zone is not necessarily limited to coming from a single slit region. Instead, the light source can be provided by several slit regions, preferably being thinner, so as to improve the smooth movement. The total width of the thinner slit regions is equivalent to the width of a single slit region. FIG. 4 is the example of control manner by taking three slit regions as a unit.

FIG. 5 is a drawing, schematically illustrating the structure of the tracking-slit panel, according to a preferred embodiment of the invention. In FIG. 5, the tracking-slit panel 140 is a schematic plane view of the tracking-slit panel 102 of FIG. 1. The tracking-slit panel 140 includes multiple slit regions 142 arranged in parallel. If the tracking-slit panel 140 is a design without emitting light, each of the slit regions 142 can be turn on or turned off, so as to let the display light pass or not pass. In addition, if the slit regions 142 of the tracking-slit panel 140 are formed from light emitting devices, such as light emitting diode (LED), then the slit region 142 can be directly controlled to emit the light.

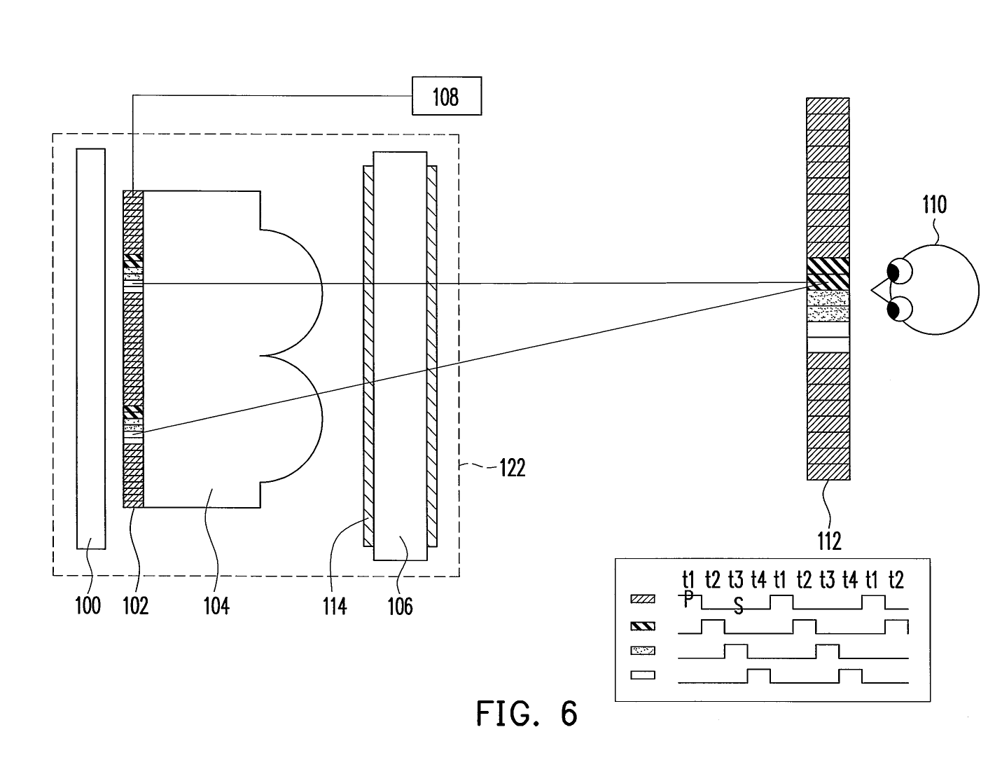

FIG. 6 is a drawing, schematically illustrating another operation mechanism, according to a preferred embodiment of the invention. In FIG. 6, the design for the image display apparatus 122 is similar to the foregoing image display apparatus 120, the difference is that the number of sets (subsets) of the slit group with respect to each lenticular bar is greater than two, such as four subsets, which is in accordance with the displaying speed of the image display panel by greater than two times, such as four times of fast displaying speed. In addition, the image display panel 106 of the image display apparatus 122 can alternatively produce image for more than two view zones under a sequence, such as four parallax images for viewing by the viewer 110 at the parallax space 112. At this moment, if both eyes of the viewer 110 are at different view zones, a stereo image can be seen. In FIG. 6, one view zone is, for example, provided with the displaying light from two slit regions. As to the situation of multiple viewers or moving viewer, the control mechanism is still the same and can be in combination.

The further control and adjustment for FIG. 6 are described as follows. The operation frequency of the image display panel 106 can be properly increased if it is necessary. For example, a few times of the visual frequency, such as 240 Hz, is set, so as to display the images of different view zones under a frequency of 60 Hz, as the example. For the embodiment of FIG. 6, there are the images for four view zones to be displayed. The displaying time sequence is for example shown at the right lower drawing. In periods of t1, t2, t3, and t4, the corresponding four parallax images are respectively displayed. When both eyes of the viewer are at different view zones, a stereo effect can be generated. As a result, even if the tracking module produces a temporary error so as to loose the viewer for a short time, a good viewer-tracking function can be still maintained.

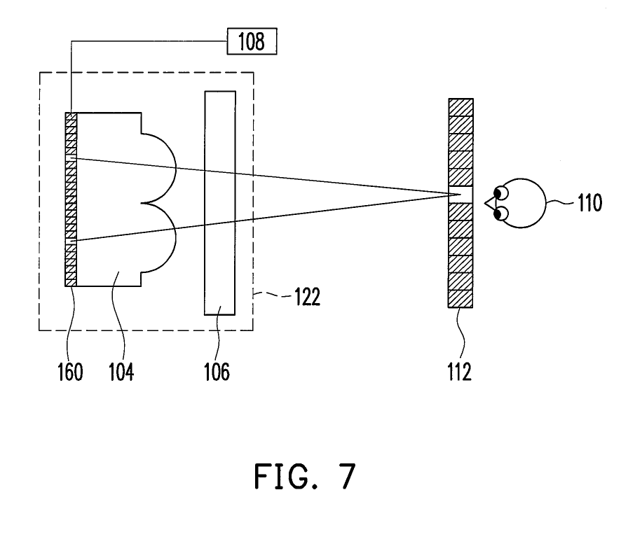

FIG. 7 a top view, schematically illustrating another structure of an autostereoscopic image display apparatus, according to a preferred embodiment of the invention operation mechanism. In FIG. 7, the image display apparatus of the embodiment is about similar to the structure of FIG. 1, and the difference is the design of the light source and tracking-slit panel. With the same displaying mechanism, the tracking-slit panel 160 is designed with actively emitting light. Therefore, it does not need a backlight module. As to control of the tracking-slit panel 160, it is still the same. In FIG. 7, the light-emitting slit region is, for example, corresponding to the right eye of the viewer, and the other slit regions are belonging to the left-eye view zone. The slit region with actively emitting light can be formed from the light emitting devices, such as LED, organic LED (OLED), or polymer LED (PLED). The light emitting device can also be other types of light emitting device but not described in each.

The image display apparatus may be based on the structure of FIG. 1 and have other modifications, such as FIGS. 2-7. Remarkably, the invention is not limited to the embodiments and not limited to the individual structures of embodiments. In other words, the invention may be based on the embodiments and taking some portion of the embodiments in combination, so as to have the actual need in practical design.

In general, the present invention can have various design choices. For example, an embodiment of the image display apparatus of the invention, each of slit regions of the tracking-slit panel includes an active light emitting device, to serve as a display light source.

In an embodiment of the image display apparatus of the invention, each of slit regions of the tracking-slit panel is a spatial light modulator (SLM) for controlling whether or not a light to pass through, and it further includes a backlight module at a back side of the tracking-slit panel to produce a display light source. Wherein, according to the on/off state of the slit regions, it is determined whether or not the display light source passes through the slit regions.

In an embodiment of the image display apparatus of the invention, the slit regions of each of the slit groups are configured into multiple view-angle zones.

In an embodiment of the image display apparatus of the invention, each of view-angle regions includes at least one of the slit regions.

In an embodiment of the image display apparatus of the invention, the first set and the second set of the slit regions of each of the slit groups are corresponding to a left eye and a right eye, and vice versa.

In an embodiment of the image display apparatus of the invention, the first set of each slit group includes at least one of the slit regions, the second set each slit group includes the other portion of the slit regions.

In an embodiment of the image display apparatus of the invention, when the viewing position is moving, the detection and control unit controls the tracking-slit panel according to the viewing position after moving.

In an embodiment of the image display apparatus of the invention, when multiple viewers are at different viewing positions, the detection and control unit accordingly divides the first set of the slit regions of each slit group into multiple subsets, corresponding to the viewing positions. In addition, each of the subsets can include at least one of the slit regions.

In an embodiment of the image display apparatus of the invention, the detection and control unit can detect whether or not at least one viewer appears within a stereo display region.

In summary, the invention uses the control on the tracking-slit panel, in associating with the image display panel, to display the images of the corresponding view zones in a time sequence. The number of viewers is not limited to one person, and the position of the viewers can be tracked when the viewers move. Using multiple slit regions and multiple parallax images, the tracing is easy and the tracking quality is smooth. Since the invention just needs to dispose the lenticular plate and the tracking-slit panel on the back side of the image display panel, the volume can also be reduced.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An image display apparatus, capable of displaying a stereo image or a planar image under switching, comprising:
an image display panel, with respect to a display image, at least two parallax images being alternatively displayed under an operation frequency, and two parallax images forming a stereo image, wherein the operation frequency is at least two times of a visual frequency, a first side of the image display panel has at least one viewing position to view the stereo image;
a tracking-slit panel, disposed at a second side of the image display panel, wherein the tracking-slit panel has multiple slit regions arranging in parallel and the slit regions extend along a pixel column direction of the image display panel;
a lenticular plate, disposed between the image display panel and the tracking-slit panel, wherein the lenticular plate has multiple parallel lenticular bars, in which every fixed number of the slit regions of the tracking-slit panel are set as a slit group, corresponding to one of the lenticular bars; and
a detection and control unit, determining whether or not a viewer is in front of the display and the stereo image is to be displayed at the viewing position and controlling each of the slit regions of the tracking-slit panel, wherein, according to the viewing position, the slit regions of each of the slit groups are at least divided into a first set and a second set, respectively corresponding to the two parallax images and alternatively turning the slit regions on/off,
wherein light passes the image display panel and reaches to the viewing position by the lenticular plate, according to an on/off state of each of the slit regions.

2. The image display apparatus of claim 1, wherein each of the slit regions of the tracking-slit panel comprises an active light emitting device, to serve as a display light source.

3. The image display apparatus of claim 1, further comprising a backlight module at a back side of the tracking-slit panel to produce a display light source, wherein, according to an on/off state of the slit regions, it is determined whether or not the display light source passes through the slit regions.

4. The image display apparatus of claim 1, wherein the slit regions of each of the slit groups are configured into multiple view-zones.

5. The image display apparatus of claim 4, wherein each of the view-zones comprises at least one of the slit regions.

6. The image display apparatus of claim 1, wherein the first set and the second set of the slit regions of each of the slit groups are corresponding to a left eye and a right eye, and vice versa.

7. The image display apparatus of claim 1, wherein the first set of each of the slit groups comprises at least one of the slit regions, the second set each slit group comprises the other portion of the slit regions.

8. The image display apparatus of claim 1, wherein when the viewing position is moving, the detection and control unit controls the tracking-slit panel according to the updated viewing position.

9. The image display apparatus of claim 1, wherein when multiple viewers are at different viewing positions, the detection and control unit accordingly divides the first set of the slit regions of each of the slit groups into multiple subsets, corresponding to the viewing positions.

10. The image display apparatus of claim 9, wherein each of the subsets can include at least one of the slit regions.

11. The image display apparatus of claim 1, wherein a view angle difference exists between the two parallax images in forming stereo effect.

12. The image display apparatus of claim 1, wherein the detection and control unit detects whether or not at least one viewer appears within a stereo display region, in which the position of the viewer is the position of the viewing position.

13. The image display apparatus of claim 1, wherein the detection and control unit, in accordance with the parallax images, controls the corresponding slit regions of the tracking-slit panel to be the on/off state, so as to project the parallax images to the left and right eyes of the viewer, or the viewing position.

14. The image display apparatus of claim 13, further comprising a backlight module at a back side of the tracking-slit panel, to produce a display light source.

15. The image display apparatus of claim 13, wherein each of the parallax images corresponds to at least one of the slit regions.

16. The image display apparatus of claim 13, wherein when the viewing position is moving, the detection and control unit controls the tracking-slit panel according to the updated viewing position.

17. The image display apparatus of claim 1, wherein the image display panel comprises a liquid crystal display panel.
